(19) United States
(12) Patent Application Publication
(10) Pub. No.: US 2020/0118280 A1
(43) Pub. Date: Apr. 16, 2020

(54) Image Processing Device

(71) Applicant: Hitachi Automotive Systems, Ltd., Hitachinaka-shi, Ibaraki (JP)

(72) Inventors: Keisuke INATA, Tokyo (JP); Mitsuhiro OKADA, Tokyo (JP); Shinichi NONAKA, Hitachinaka-shi (JP)

(21) Appl. No.: 16/627,117

(22) PCT Filed: May 24, 2018
(86) PCT No.: PCT/JP2018/019980

§ 371 Date: Dec. 27, 2019

(30) Foreign Application Priority Data
Jun. 30, 2017 (JP) 2017-128821

(51) Int. Cl. G06T 7/285; G06T 7/11; G06T 7/246; G01P 3/38; G06T 7/80

(52) U.S. Cl. CPC G06T 7/285; G06T 7/11; G06T 2207/30252; G01P 3/38; G06T 7/80; G06T 7/246

(57) ABSTRACT

An image processing device is an image processing device mounted on a vehicle. The image processing device includes: a captured image input part to which a plurality of captured images having different photographing sensitivities are input; a combined image input part to which a combined image with high gradation generated using the plurality of captured images is input; a feature information generation part that generates predetermined feature information using an input image; and a determination part that determines an image to be input to the feature information generation part as one of the combined image and the captured images on a basis of at least one of a state of the vehicle and a state around the vehicle.

### TECHNICAL FIELD

The present invention relates to an image processing device.

### BACKGROUND ART

A technique is known in which a distance between a camera and an observation object is calculated using a stereo camera and recognition processing of the observation object is performed. For example, in PTL 1, an image processing device 1 mounted on a host vehicle 400 as a moving body such as an automobile includes a stereo image processing part 200 that analyzes a captured image which is captured by an imaging unit 100 that captures a captured image of a front area (imaging area) in the traveling direction of the host vehicle and detects a recognition object such as a pedestrian existing in the imaging area. In the stereo image processing part 200, a configuration is disclosed which detects a recognition object on the basis of a horizontal parallax diagram, collates the recognition object area luminance image corresponding to the recognition object with the pattern image of a dynamic dictionary 258, and determines whether or not it is the recognition object.

### CITATION LIST

### Patent Literature

PTL 1: JP 2007-172035 A

### SUMMARY OF INVENTION

### Technical Problem

In the present invention described in PTL 1, in order to obtain information on a plurality of subjects having different brightness, it is necessary to perform photographing under the photographing condition suitable for each subject and to process each obtained image. Thus, the calculation cost for obtaining information on the plurality of subjects having different brightness is high.

### Solution to Problem

An image processing device according to a first aspect of the present invention is an image processing device mounted on a vehicle. The image processing device includes: a captured image input part to which a plurality of captured images having different photographing sensitivities are input; a combined image input part to which a combined image with high gradation generated using the plurality of captured images is input; a feature information generation part that generates predetermined feature information using an input image; and a determination part that determines an image to be input to the feature information generation part as one of the combined image and the captured images on a basis of at least one of a state of the vehicle and a state around the vehicle.

### Advantageous Effects of Invention

According to the present invention, the information on the plurality of subjects having different brightness can be obtained efficiently.

### BRIEF DESCRIPTION OF DRAWINGS

FIG. 1 is a configuration diagram of an image processing system S in a first embodiment.

FIG. 2 is a diagram for explaining an operation of a determination part 60 when a first criterion is adopted.

FIG. 3 is a diagram illustrating an operation example of a first image combining part 20 when the first criterion is adopted.

FIG. 4 is a diagram illustrating whether or not distance information of a bright portion and a dark portion can be calculated when the first criterion, a first comparative example, and a second comparative example are adopted.

FIG. 5 is a diagram for explaining an operation of the determination part 60 when a second criterion is adopted.

FIG. 6 is a diagram for explaining an operation of the determination part 60 when a third criterion is adopted.

FIG. 7 is a diagram for explaining an operation of the determination part 60 when a fourth criterion is adopted.

FIG. 8 is a diagram for explaining an operation of the determination part 60 when a fifth criterion is adopted.

FIG. 9 is a schematic diagram of an image obtained by photographing a front of the mounted vehicle.

FIG. 10 is a diagram illustrating a generation example of a congestion degree.

FIG. 11 is a diagram for explaining an operation of the determination part 60 when a sixth criterion is adopted.

FIG. 12 is a diagram for explaining an operation of the determination part 60 when a seventh criterion is adopted.

FIG. 13 is a configuration diagram of the image processing system S in a second embodiment.

FIG. 14 is a configuration diagram of an image processing system S in a third embodiment.

FIG. 15 is a configuration diagram of an image processing system S in a fourth embodiment.

FIG. 16 is a diagram illustrating an example of dividing a captured image 1215 into processing areas in a fifth embodiment.

FIG. 17 is a diagram for explaining an operation of the determination part 60 when an eighth criterion is adopted.

FIG. 18 is a configuration diagram of a distance information generation part 50 in the sixth embodiment.

FIG. 19 is a diagram for explaining an operation of the determination part 60 when a distance information criterion is adopted.

FIG. 20 is a diagram illustrating processing of the distance information generation part 50.

### DESCRIPTION OF EMBODIMENTS

### First Embodiment

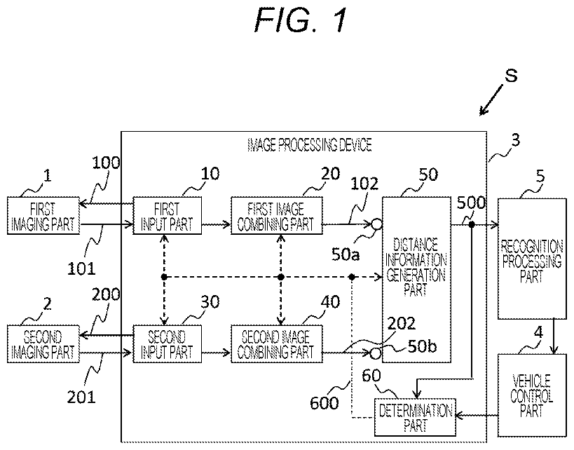

Hereinafter, a first embodiment of an image processing device will be described with reference to FIGS. 1 to 12.

### (Configuration)

FIG. 1 is a configuration diagram of an image processing system S including an image processing device 3. The image processing system S includes a first imaging part 1, a second imaging part 2, an image processing device 3, a vehicle control part 4, and a recognition processing part 5. The image processing system S is mounted on a vehicle. Hereinafter, the vehicle on which the image processing system S is mounted is also referred to as a “mounted vehicle”.

The first imaging part 1 is, for example, a camera. The first imaging part 1 photographs a subject on the basis of a photographing instruction 100 from the image processing device 3 and outputs an obtained image 101 to the image processing device 3. When the first imaging part 1 receives one photographing instruction 100, the first imaging part 1 performs so-called auto bracket photographing which photographs with two different types of exposure times and outputs two images to the image processing device 3. In the following, the two types of exposure times are called “short exposure time” and “long exposure time”, and the images obtained by the respective exposures are called “image A” and “image B”. That is, the image 101 is a plurality of images configured by the image A and the image B and having different exposure times. Incidentally, in the following, the different exposure times are also referred to as “different photographing sensitivities”. Incidentally, strictly, the images A and B are images obtained by photographing at different times. Thus, for example, when the mounted vehicle is moving, the subject in the image A and the subject in the image B are photographed at different positions in the captured image.

The second imaging part 2 is a camera, for example. The second imaging part 2 photographs the subject on the basis of a photographing instruction 200 from the image processing device 3 and outputs an obtained image 201 to the image processing device 3. The functions and operations of the second imaging part 2 are the same as those of the first imaging part 1. An image obtained by photographing with the second imaging part 2 during a short exposure time is also called “image A”, and an image obtained by photographing with the second imaging part 2 during a long exposure time is also called “image B”. That is, the image 201 is a plurality of images configured by the image A and the image B and having different exposure times.

The image processing device 3 is a computer including a CPU, a ROM, a RAM, and an interface (not illustrated). The CPU develops and executes the program stored in the ROM on the RAM, thereby realizing the functions described later. However, the image processing device 3 may be configured by an ASIC or FPGA instead of the CPU, ROM, and RAM. The image processing device 3 processes the images input from the first imaging part 1 and the second imaging part 2, generates distance information, and outputs the distance information to the recognition processing part 5.

The image processing device 3 includes a first input part 10 to which an image 101 supplied from the first imaging part 1 with different photographing sensitivities is input, a first image combining part 20 having a function of combining the image 101 with different photographing sensitivities into a single image, a second input part 30 to which an image 201 supplied from the second imaging part 2 with different photographing sensitivities is input, and a second image combining part 40 having a function of combining the image 201 with different photographing sensitivities into a single image. However, the first image combining part 20 and the second image combining part 40 may output any one of the input images having different photographing sensitivities as it is. That is, the first image combining part 20 and the second image combining part 40 output one of the image A, the image B, and the combined image (hereinafter, “combined image”). The output image is determined by a mode command signal 600 input from a determination part 60 described later. The first image combining part 20 and the second image combining part 40 may always create a combined image or may create a combined image only in the case of outputting the combined image. The first input part 10 and the second input part 30 receive information indicating the processing timing from the determination part 60 and perform processing at that timing.

The image combination in the first image combining part 20 and the second image combining part 40 is creation of a so-called high dynamic range (HDR) image. The image output from the first image combining part 20 is referred to as an image 102, and the image output from the second image combining part 40 is referred to as an image 202. Incidentally, the first image combining part 20 and the second image combining part 40 may perform image processing other than combination processing such as enhancer processing and scaler processing. The enhancer processing is a process of extracting and sharpening edges, and the scaler processing is a process of enlarging or reducing an image. The image processing device 3 further includes a distance information generation part 50 that generates distance information using the image 102 supplied from the first image combining part 20 and the image 202 supplied from the second image combining part 40 and a determination part 60 that determines an image to be supplied to the distance information generation part 50 and outputs a mode command signal 600.

The distance information generation part 50 generates distance information using the image 102 and the image 202 by a known distance information generation algorithm. The first imaging part 1 and the second imaging part 2 have a predetermined baseline distance, and the positional relationship between the first imaging part 1 and the second imaging part 2 is known. The distance information generation part 50 calculates the correspondence of the pixels between the first imaging part 1 and the second imaging part 2 and calculates the distance to the subject using the fact that the parallax is larger, that is, the distance between the corresponding pixels in the captured image of the first imaging part 1 and the captured image of the second imaging part 2 is longer as the distance from the subject is shorter. The calculated distance information is output to the recognition processing part 5 as indicated by reference numeral 500. Incidentally, the calculation of distance information is required to calculate the correspondence between the pixels of the first imaging part 1 and the second imaging part 2 as described above, and thus a processing load is high. In addition, the distance information generation part 50 also outputs the images input from the first image combining part 20 and the second image combining part 40 to the recognition processing part 5 in accordance with the content of the recognition processing executed by the recognition processing part 5.

The distance information generation part 50 includes a first port 50a and a second port 50b that are virtual input ports. The image output from the first image combining part 20 is input from the first port 50a, and the image output from the second image combining part 40 is input from the second port 50b. The distance information generation part 50 receives information indicating processing timing from the determination part 60 and performs processing at that timing.

The distance information generation part 50 may receive a non-combined image, that is, an image A or an image B, or a combined image. However, the type of the image input from the first image combining part 20 and the type of the image input from the second image combining part 40 are always the same. Therefore, the distance information generation part 50 generates distance information using the image 102 and the image 202 similarly in any case. In addition, in this embodiment, the time interval of images input to the distance information generation part 50, that is, the frame rate is constant.

On the basis of the distance information output from the recognition processing part 5 or the information of the mounted vehicle acquired from the CAN network (not illustrated), the vehicle control part 4 outputs travel information of the mounted vehicle or periphery information of the mounted vehicle (hereinafter, “vehicle peripheral information”) to the image processing device 3. The vehicle control part 4 may further perform subject detection processing based on information processed by the image processing device 3. In addition, the vehicle control part 4 may display the image obtained from the first imaging part 1 as it is on a display device (not illustrated) connected to the vehicle control part 4 or may highlight and display the subject detected by subject detection processing. The vehicle control part 4 may further supply information on an observation object detected by the vehicle control part 4 to an information device (not illustrated) that processes traffic information such as map information and traffic jam information. The recognition processing part 5 performs various recognition processes based on the information generated by the image processing device 3 as described later.

### (Specific Example of Function of Vehicle Control Part 4)

An example of the travel information output by the vehicle control part 4 includes a host vehicle speed, a host vehicle acceleration, a host vehicle traveling direction, a steering angle, brake information, a travel mode type, and vehicle control information. An example of the vehicle periphery information output by the vehicle control part 4 includes a congestion degree around the host vehicle or a predicted value of the congestion degree, a distance to the subject, a speed of the subject, a relative speed with the subject, host vehicle position information, map information, traffic jam information, past accident information, and road surface conditions.

An example of the travel mode mentioned as an example of the travel state includes a travel mode based on a travel path, a travel mode based on a travel condition, a travel mode based on a peripheral natural environment, and an energy saving mode for traveling with low power consumption or low fuel consumption. An example of the travel mode based on the travel path includes an urban travel mode, an expressway travel mode, and legal speed information. An example of the travel mode based on the travel condition includes a travel mode in a traffic jam, a parking lot mode, and a travel mode according to the position and movement of peripheral vehicles. An example of the travel mode based on the peripheral natural environment includes a night travel mode, and a backlight travel mode.

An example of the map information includes position information of the mounted vehicle on the map, road shape information, road surface feature information, road width information, lane information, and road gradient information. An example of the road shape information includes T-junctions, and intersections. An example of the road surface feature information includes a signal, a roadway part, a sidewalk part, a railroad crossing, a bicycle parking lot, a car parking lot, and a pedestrian crossing. An example of the traffic information includes traffic jam information, traffic regulation information such as speed restriction and traffic prohibition, and travel route guidance information for guiding to another travel route. An example of the vehicle control information includes brake control, steering wheel control, accelerator control, in-vehicle lamp control, warning sound generation, in-vehicle camera control, and information on observation objects around the imaging device output to peripheral vehicles and remote center devices connected via a network Information.

### (Specific Example of Function of Recognition Processing Part 5)

Recognition targets in the recognition processing part 5 includes, for example, subject position information, type information, motion information, and danger information. An example of the position information includes a direction, a distance, and the like from the mounted vehicle. The type information is information indicating the types of pedestrians, adults, children, elderly people, animals, falling rocks, bicycles, peripheral vehicles, peripheral structures, and curbs. An example of the motion information includes the wobbling, the jumping out, the traversing, the moving direction, the moving speed, and the moving trajectory of a pedestrian or a bicycle. An example of the danger information includes pedestrian jumping, falling rocks, and the abnormal operation of peripheral vehicles such as sudden stop, sudden deceleration, and sudden steering.

### (Feature of Image A, Image B, and Combined Image)

In the image A obtained during a short exposure time, a subject with high brightness tends to be recorded in an identifiable manner, and a subject with low brightness tends to be difficult to be recorded in an identifiable manner. Therefore, the image A is effective for grasping the surrounding situation in the daytime when the amount of light is large. In addition, in urban areas, there is a possibility that pedestrians move around the mounted vehicle. Thus, quick detection is required, and the usefulness of the image A is high. In the image B obtained during the long exposure time, a subject with high brightness tends to be difficult to be recorded in an identifiable manner, and a subject with low brightness tends to be difficult to be recorded in an identifiable manner. Therefore, image B is effective for grasping the surrounding situation at night when the amount of light is small.

When comparing the image A and the image B, there is a possibility that the subject is recorded in image B in an identifiable manner even in an area (hereinafter, “blackout”) which is displayed in black with a small amount of light in the image A. In addition, there is a possibility that the subject is recorded in image A in an identifiable manner even in an area (hereinafter, “whiteout”) which is displayed in white due to a large amount of light in the image B. In this regard, by combining the image A and the image B as follows, a combined image with reduced blackout and whiteout can be obtained. In the following, the area where the blackout area is displayed in the image A, and the subject is recorded in an identifiable manner in the image B is referred to as a “dark portion”, and the area where the whiteout area is displayed in the image B, and the subject is recorded in an identifiable manner in the image A is referred to as a “bright portion”.

The combination processing for creating the combined image is realized by the following known method. The combination processing includes, for example, a dynamic range expansion processing and a gradation compression processing. The dynamic range expansion processing is a process of increasing the luminance gradation of each pixel by superimposing the luminance information of the image A and the luminance information of the image B. At this time, the luminance information of the image A and the luminance information of the image B may be multiplied by a coefficient corresponding to the exposure time. Incidentally, only the luminance information has been described as the processing target of the combination processing, but the same processing may be performed for each of RGB. The subsequent gradation compression processing is a process of reducing the luminance gradation of each pixel increased by the dynamic range expansion processing to a gradation that can be handled by the subsequent processing. However, in a case where the distance information generation part 50 can process a high gradation image, the gradation compression processing may be omitted. The combined image created in this way has higher gradation than the original image A and image B, and the whiteout and the blackout are reduced. However, in a case where the mounted vehicle is moving, the subject is photographed at different positions in the image A and the image B. Thus, the subject is unclear in the combined image. This tendency becomes more prominent as the moving speed of the mounted vehicle increases. Incidentally, the combination processing has a sufficiently low processing load compared to the processing for calculating the distance information executed by the distance information generation part 50.

### (Determination Part 60)

The determination part 60 stores seven preset criteria, that is, first criterion to seventh criterion. The criterion adopted by the determination part 60 is determined by an external input, for example, a setting by a user using the image processing system S or an operation command from an external server received from a communication interface (not illustrated). The determination part 60 determines an image to be input to the distance information generation part 50 on the basis of the criterion to be adopted, the state of the mounted vehicle, and the like. Hereinafter, the operation of the determination part 60 in each of the first criterion to the seventh criterion will be described.

### (First Criterion)

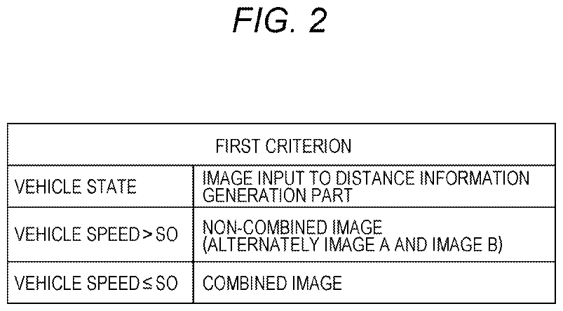

FIG. 2 is a diagram for explaining the operation of the determination part 60 when the first criterion is adopted. In a case where the first criterion is adopted, the determination part 60 evaluates the vehicle speed of the mounted vehicle and determines whether or not the vehicle speed is faster than a predetermined speed S0. In a case where it is determined that the vehicle speed of the mounted vehicle is faster than S0, the determination part 60 outputs the mode command signal 600 for instructing to alternately output the image A and the image B to the first image combining part 20 and the second image combining part 40. In a case where it is determined that the vehicle speed of the mounted vehicle is equal to or less than S0, the determination part 60 outputs the mode command signal 600 for instructing the output of the combined image to the first image combining part 20 and the second image combining part 40.

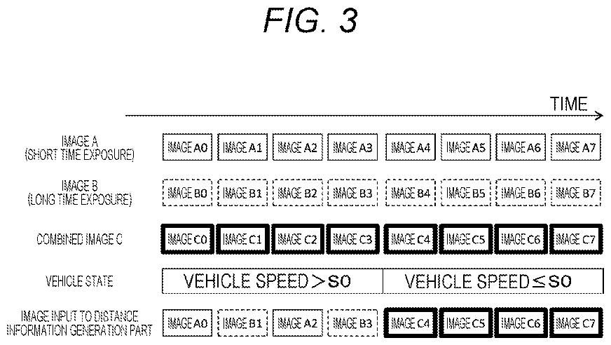

FIG. 3 is a diagram illustrating an operation example of the first image combining part 20 when the first criterion is adopted. However, in FIG. 3, for the purpose of explanation, the first image combining part 20 creates a combined image regardless of the mode command signal 600 input from the determination part 60. In addition, in FIG. 3, serial numbers are assigned to the created images in time series. That is, the image A1 is created after the image A0. In addition, here, the combined image is represented by being given reference numeral C, so as to indicate that the combined image C is created from the image A and the image B having the same number. That is, an image C0 is created from the image A0 and the image B0. In FIG. 3, time has passed from the left to the right in the drawing, and the vehicle speed is faster than S0 until the middle time illustrated in the drawing, but after that, the vehicle speed becomes S0 or less.

In such a case, in a case where the vehicle speed is faster than S0, the first image combining part 20 is instructed to output non-combined images alternately. For this reason, the image A and the image B are alternately input to the distance information generation part 50 as illustrated in A0, B1, A2, and B3 at the bottom of FIG. 3. Further, when the vehicle speed becomes equal to or less than S0, the first image combining part 20 is instructed to output a combined image. Thus, the combined image is input to the distance information generation part 50. Therefore, in a case where the vehicle speed is S0 or less, the recognition processing part 5 can obtain the distance information of the subject photographed in the dark portion and the bright portion whenever the distance information generation part 50 calculates the distance information. Incidentally, in a case where the vehicle speed is S0 or less, the distance information can be calculated for each of the image A and the image B. However, there are the following problems.

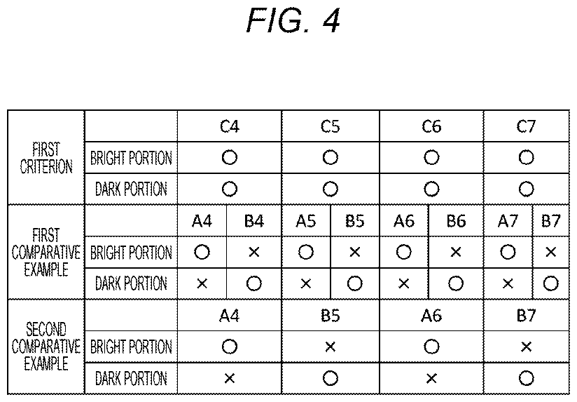

FIG. 4 is a diagram illustrating whether or not the distance information of the bright portion and the dark portion can be calculated in a case where the above-described first criterion is adopted and a case where the first comparative example and the second comparative example are adopted. The upper part of FIG. 4 corresponds to the right half in FIG. 3, that is, a case where the vehicle speed is S0 or less. In the case of the criterion 1 illustrated in the upper part of FIG. 4, by using each of C4 to C7, accurately, by using the same combined image output from the second image combining part 40 together, the distance information generation part 50 generates distance information. Further, since the information of the bright portion and the dark portion is obtained in the combined image, the distance information of the bright portion and the dark portion is obtained even in a case where any image is used. In a case where the criterion 1 is adopted, the distance information is calculated four times in the range illustrated in FIG. 4.

In the case of the first comparative example illustrated in the middle part of FIG. 4, the distance information is calculated using each of the image A and the image B without creating a combined image. In a case where the image A is used for calculating the distance information, the distance information of the bright portion can be obtained, but the distance information of the dark portion cannot be obtained. In a case where the image B is used for calculating the distance information, the distance information of the dark portion can be obtained but the distance information of the bright portion cannot be obtained. That is, when the distance information calculated using the image A and the distance information calculated using the image B are combined, the distance information of the bright portion and the dark portion can be obtained as in a case where the first criterion is adopted. However, in the first comparative example, the number of calculating the distance information in the range illustrated in FIG. 4 is eight. That is, the number is twice that in a case where the criterion 1 is adopted. In other words, in a case where the first criterion is adopted, the calculation cost of the distance information can be reduced to half, compared to the first comparative example.

In the case of the second comparative example illustrated in the lower part of FIG. 4, the distance information is generated by alternately using the image A and the image B as in the case where the vehicle speed is higher than S0 in the first criterion. In the case of the second comparative example, the number of calculating the distance information in the range illustrated in FIG. 4 is four, and the calculation cost of the distance information is the same as that of the first criterion. However, the distance information can be obtained only once for each of the dark portion and the bright portion. In other words, in a case where the first criterion is adopted, the acquisition frequency of the distance information of the lightness and the dark portion is twice that of the second comparative example.

In this way, when the first criterion is adopted, in a case where the vehicle speed of the mounted vehicle exceeds the predetermined value S0, the distance information is generated for a non-combined image with less blur of the subject. Thus, the distance information generation part 50 can accurately calculate the distance information also for a distant subject, and the recognition processing part 5 can also recognize a distant subject. On the other hand, in a case where the vehicle speed of the mounted vehicle is equal to or less than the predetermined value S0, the distance information is generated for the combined image. Thus, the calculation cost and the acquisition frequency of the distance information are excellent as illustrated in the comparison with the first comparative example and the second comparative example. Further, in a case where the first criterion is adopted, the frequency of images input to the distance information generation part 50, that is, the frame rate is constant even if the vehicle speed changes, and thus, it is possible to prevent fluctuations in processing load. Incidentally, although not mentioned in the second criterion to the seventh criterion described below, in a case where the combined image is used, the second criterion to the seventh criterion similarly have advantages over the first comparative example and the second comparative example.

### (Second Criterion)

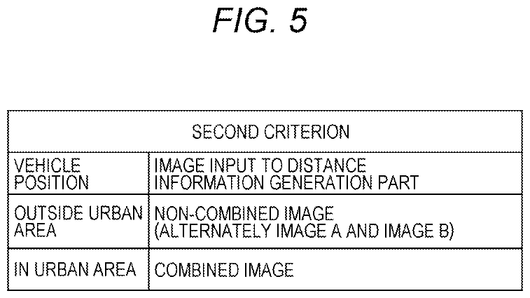

FIG. 5 is a diagram for explaining the operation of the determination part 60 when the second criterion is adopted. In a case where the second criterion is adopted, the determination part 60 evaluates the position of the mounted vehicle and determines whether the mounted vehicle is in the urban area or outside the urban area. This determination may be made by the determination part 60 itself on the basis of the position information of the mounted vehicle and the position information of the urban area provided by the vehicle control part 4 or may be made by the signal indicating either the inside of the urban area and the outside of the urban area input from the vehicle control part 4. In a case where it is determined that the mounted vehicle is present outside the urban area, the determination part 60 outputs the mode command signal 600 for instructing to alternately output the image A and the image B to the first image combining part 20 and the second image combining part 40. In a case where it is determined that the mounted vehicle is present in the urban area, the determination part 60 outputs the mode command signal 600 for instructing output of the combined image to the first image combining part 20 and the second image combining part 40. When the second criterion is adopted, the image processing device 3 can appropriately generate the distance information on the basis of the location of the mounted vehicle.

### (Third Criterion)

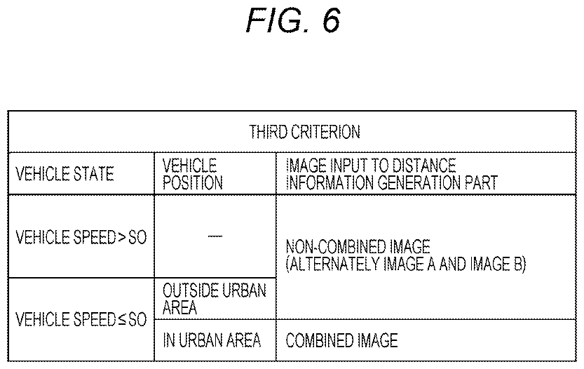

FIG. 6 is a diagram for explaining the operation of the determination part 60 when the third criterion is adopted. In a case where the third criterion is adopted, the determination part 60 evaluates the vehicle speed and position of the mounted vehicle. In a case where it is determined that the mounted vehicle is present in the urban area, and the vehicle speed is equal to or less than S0, the determination part 60 outputs the mode command signal 600 for instructing the output of the combined image to the first image combining part 20 and the second image combining part 40. In other cases, the determination part 60 outputs the mode command signal 600 for instructing to alternately output the image A and the image B to the first image combining part 20 and the second image combining part 40. When the third criterion is adopted, the image processing device 3 can appropriately generate the distance information on the basis of the vehicle speed and the location of the mounted vehicle.

### (Fourth Criterion)

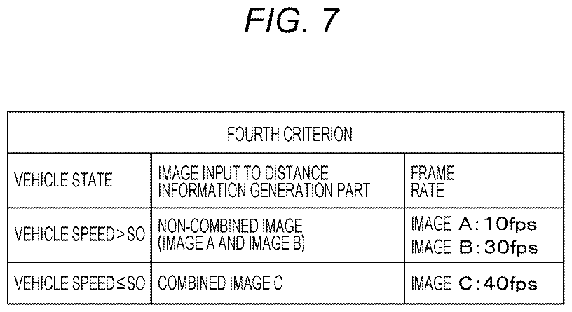

FIG. 7 is a diagram for explaining the operation of the determination part 60 when the fourth criterion is adopted. The fourth criterion is similar to the first criterion and is different from the first criterion in that the ratio of the image A and the image B is 1:3 in a case where the vehicle speed is faster than the speed S0. In a case where the vehicle speed is faster than the speed S0 in the fourth criterion, the first image combining part 20 outputs three images B after outputting one image A, and then outputs one image A again. In the fourth criterion, the input frequency of the image B with a long exposure time is high, and thus specifications such as nighttime or rainy weather are suitable. Incidentally, even at nighttime, a portion illuminated by headlight has a large amount of light, and thus, the recognition using the image A is effective. In addition, even when this criterion is adopted, the frame rate of the image input to the distance information generation part 50 is constant regardless of the vehicle state.

### (Fifth Criterion)

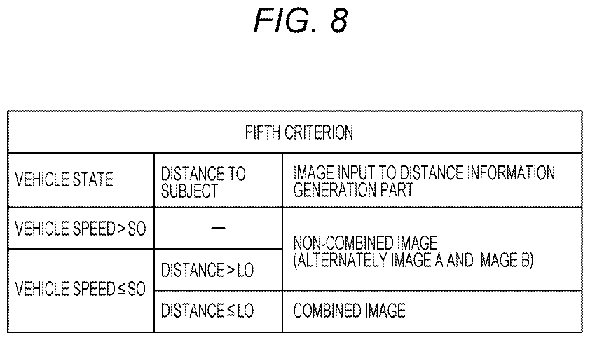

FIG. 8 is a diagram for explaining the operation of the determination part 60 when the fifth criterion is adopted. In a case where the fifth criterion is adopted, the determination part 60 evaluates the vehicle speed of the mounted vehicle and the distance to the subject. In a case where it is determined that the distance to the subject is equal to or less than the predetermined distance L0, and the vehicle speed is equal to or less than S0, the determination part 60 outputs the mode command signal 600 for instructing the output of the combined image to the first image combining part 20 and the second image combining part 40. In other cases, the determination part 60 outputs the mode command signal 600 for instructing to alternately output the image A and the image B to the first image combining part 20 and the second image combining part 40. Incidentally, in a case where a plurality of subjects are present, the distance of the closest subject is evaluated. When the fifth criterion is adopted, the image processing device 3 can appropriately generate the distance information on the basis of the vehicle speed of the mounted vehicle and the distance to the subject.

### (Sixth Criterion)

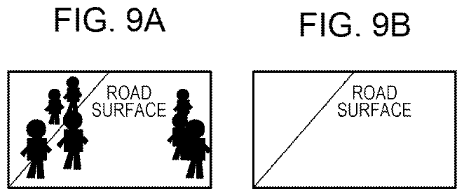

FIG. 9 is a schematic diagram of an image obtained by photographing the front of the mounted vehicle, FIG. 9(a) is a diagram illustrating a situation at the time of congestion, and FIG. 9(b) is a diagram illustrating a situation at the time of non-congestion. The sixth criterion uses the degree of congestion indicating the congestion degree. The congestion degree may be generated based on traffic information such as traffic jam information or may be generated based on the distance information or the vehicle periphery information.

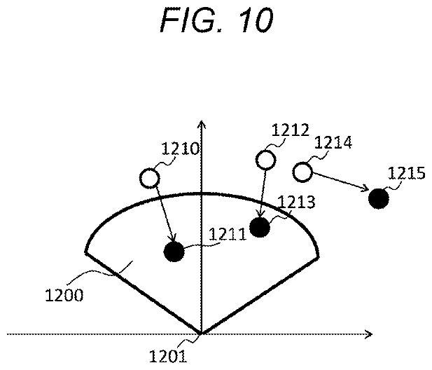

FIG. 10 is a diagram illustrating a generation example of the congestion degree. FIG. 10 illustrates subjects 1210, 1212, and 1214 at time T0 indicated by white circles, subjects 1211, 1213, and 1215 at time T0+Δt indicated by black circles, a host vehicle position 1201, and a congestion degree determination area 1200. The subjects indicated by reference numerals 1210 and 1211 are the same, the subjects indicated by reference numerals 1212 and 1213 are the same, and the subjects indicated by reference numerals 1214 and 1215 are the same. Here, the congestion degree is the number of subjects present in the congestion degree determination area 1200. At time T0, the number of subjects in the congestion degree determination area 1200 is zero, and thus the congestion degree is zero. At time T0+Δt, the subject 1211 and the subject 1213 are present in the congestion degree determination area 1200, and thus the congestion degree is two. However, although the congestion degree determination area 1200 is one area here, the congestion degree determination area 1200 may be divided into a plurality of areas, and the weight for calculating the congestion degree may be changed depending on an area.

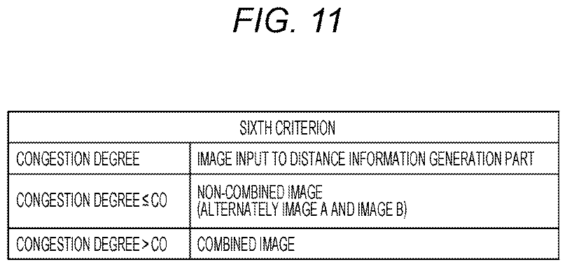

FIG. 11 is a diagram for explaining the operation of the determination part 60 when the sixth criterion is adopted. The determination part 60 evaluates the above-described congestion degree in a case where the sixth criterion is adopted. In a case where it is determined that the congestion degree is equal to or less than the predetermined congestion degree C0, the determination part 60 outputs the mode command signal 600 for instructing to alternately output the image A and the image B to the first image combining part 20 and the second image combining part 40. In a case where it is determined that the congestion degree is larger than the predetermined congestion degree C0, the determination part 60 outputs the mode command signal 600 for instructing the output of the combined image to the first image combining part 20 and the second image combining part 40.

### (Seventh Criterion)

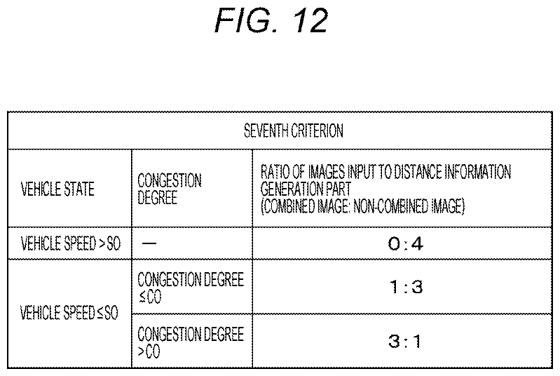

FIG. 12 is a diagram for explaining the operation of the determination part 60 when the seventh criterion is adopted. In a case where the seventh criterion is adopted, the determination part 60 evaluates the vehicle speed of the mounted vehicle and the congestion degree. In a case where it is determined that the vehicle speed of the mounted vehicle is faster than S0, the determination part 60 sets the ratio of the combined image and the non-combined image to 0:4. That is, the determination part 60 outputs the mode command signal 600 for instructing to alternately output the image A and the image B, which are non-combined images, to the first image combining part 20 and the second image combining part 40. In a case where it is determined that the vehicle speed of the mounted vehicle is equal to or less than S0 and the congestion degree is equal to or less than the predetermined congestion degree C0, the determination part 60 outputs the next mode command signal 600. That is, the determination part 60 outputs the mode command signal 600 for instructing to output the combined image and the non-combined image with the ratio as 1:3 to the first image combining part 20 and the second image combining part 40. In a case where it is determined that the vehicle speed of the mounted vehicle is equal to or less than S0 and the congestion degree is larger than the predetermined congestion degree C0, the determination part 60 outputs the next mode command signal 600. That is, the determination part 60 outputs the mode command signal 600 for instructing to output the combined image and the non-combined image with the ratio as 3:1 to the first image combining part 20 and the second image combining part 40. Incidentally, in a case where the vehicle speed is equal to or less than S0, two types of ratios are selected using the threshold value C0. However, the ratios may be changed in stages according to the congestion degree.

According to the first embodiment described above, the following effects can be obtained.

(1) The image processing device 3 is mounted on the mounted vehicle. The image processing device 3 includes: a first input part 10 and a second input part 30 to which a plurality of images having different photographing sensitivities are input; a first port 50a and a second port 50b to which combined images with high gradation generated using the plurality of images are input; a distance information generation part 50 that generates predetermined feature information using input images; and a determination part 60 that determines images to be input to the distance information generation part 50 as one of a combined image, an image A, and an image B on the basis of at least one of a state of a mounted vehicle and a state around the mounted vehicle. Therefore, when an appropriate image is input to the distance information generation part 50 according to the situation, the information of the subject of the bright portion and the subject of the dark portion, that is, the information of a plurality of subjects having different brightness can be efficiently obtained.

(2) Feature information generated by the distance information generation part 50 is distance information. Therefore, the periphery of the mounted vehicle can be recognized using the distance information.

(3) The determination part 60 further determines a frame rate of an image to be input to the distance information generation part 50 on the basis of at least one of the state of the vehicle and the state around the vehicle. Therefore, the processing load of the distance information generation part 50 can be flexibly adjusted.

(4) The determination part 60 maintains the frame rate of the image input to the distance information generation part 50 within a predetermined range regardless of the state of the vehicle and the state around the vehicle. Therefore, fluctuations in the processing load of the distance information generation part 50 can be suppressed.

(5) The state of the vehicle includes at least one of a speed of the vehicle, steering wheel operation information, and position information of the vehicle. The state around the vehicle includes a congestion degree around the vehicle or a distance from the vehicle to a subject.

(6) A plurality of images with parallax captured by a first imaging part 1 and a second imaging part 2 are input to a first input part 10 and the second input part 30. The distance from the vehicle to the subject is a distance calculated using the plurality of images with parallax. Therefore, the distance can be calculated without using an additional sensor.

(7) The congestion degree around the mounted vehicle is calculated on the basis of the distance from the mounted vehicle to the subject and a relative speed of the subject with respect to the mounted vehicle. Therefore, it is possible to calculate the congestion degree by predicting the subject moving near the mounted vehicle from the relative speed.

(8) The image processing device 3 further includes: a first image combining part 20 and a second image combining part 40 which generate combined images using a plurality of images input to the first input part 10 and the second input part 30 and input the images to the first port 50a and the second port 50b. Therefore, even when another device used together with the image processing device 3 does not have a combining function, the above-described effect can be exhibited.

### (First Modification)

The auto bracket photographing by the first imaging part 1 and the second imaging part 2 may be performed three times or more instead of two times. Further, the first imaging part 1 and the second imaging part 2 may change the aperture amount and ISO sensitivity of the lens while keeping the exposure time constant, or these may be used in combination.

### (Second Modification)

In the case where the distance information generation part 50 uses a non-combined image, in the above-described embodiment, the images such as A0 and B1 obtained by different bracket photographing are used. However, in a case where the images obtained by the same bracket photographing are used, for example, in a case where the left half of FIG. 3, that is, a non-combined image is used, the images such as A0, B0, A2, and B2 may be used.

### (Third Modification)

The image processing device 3 may be configured to include the first imaging part 1 and the second imaging part 2. Furthermore, the image processing device 3 may include the recognition processing part 5 and the vehicle control part 4. According to this modification, the following effects can be obtained.

(9) The image processing device 3 further includes a first imaging part 1 and a second imaging part 2 which photograph a periphery of the mounted vehicle with different sensitivities and input the plurality of images obtained by photographing to the first input part 10 and the second input part 30. Therefore, it is not necessary to connect the image processing device 3 to the first imaging part 1 and the second imaging part 2, and the image processing device can be used easily.

### (Fourth Modification)

The determination part 60 only needs to store at least one reference from the first criterion to the seventh criterion. In addition, any criterion, for example, the seventh criterion may be set by default and may be changed by an external input. Further, the determination part 60 may automatically select any one of the first criterion to the seventh criterion according to a predetermined criterion, for example, ambient brightness and time zone.

### Second Embodiment

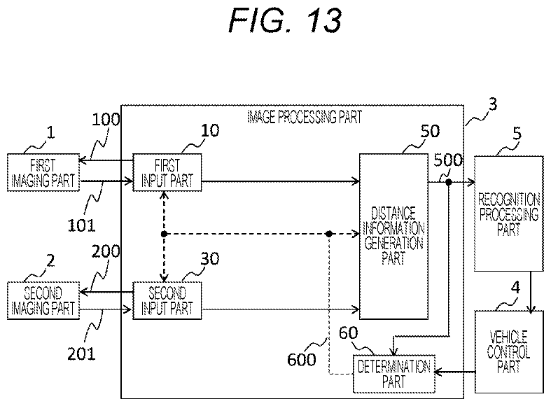

A second embodiment of the image processing device will be described with reference to FIG. 13. In the following description, the same components as in the first embodiment will be assigned the same reference numerals, and differences will be mainly described. The points that are not particularly described are the same as in the first embodiment. This embodiment is different from the first embodiment in that the imaging part has a function of configuring an image.

FIG. 13 is a configuration diagram of an image processing system S in the second embodiment. The difference from FIG. 1 in the first embodiment is that the first imaging part 1 has the function of the first image combining part 20, and the second imaging part 2 has the function of the second image combining part 40. Therefore, in this embodiment, the mode command signal 600 from the determination part 60 is input to the first imaging part 1 and the second imaging part 2 via the first input part 10 and the second input part 30. Then, the first imaging part 1 and the second imaging part 2 output a non-combined image or a combined image to the first input part 10 and the second input part 30 in accordance with the mode command signal 600. Then, the first input part 10 and the second input part 30 output the input image to the distance information generation part 50.

### Third Embodiment

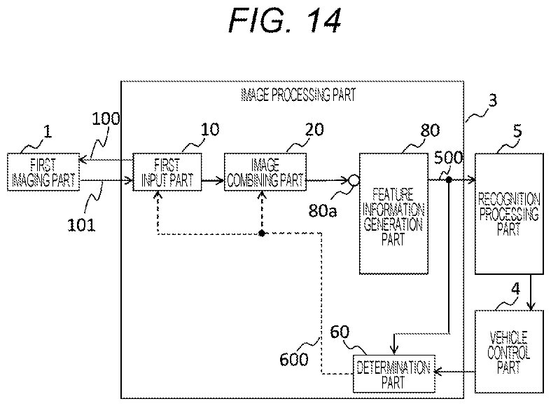

A third embodiment of the image processing device will be described with reference to FIG. 14. In the following description, the same components as in the first embodiment will be assigned the same reference numerals, and differences will be mainly described. The points that are not particularly described are the same as in the first embodiment. This embodiment is different from the first embodiment mainly in that the image processing system S includes only one imaging part.

FIG. 14 is a configuration diagram of an image processing system S in the third embodiment. The difference in the first embodiment from FIG. 1 is that the second imaging part 2, the second input part 30, and the second image combining part 40 are not provided in this embodiment. In addition, in this embodiment, a feature information generation part 80 is provided instead of the distance information generation part 50. For example, the feature information generation part 80 performs edge information extraction processing, contour extraction processing, distance information generation, pattern matching processing, variance value calculation, average value calculation, and the like for the input image 102.

### Fourth Embodiment

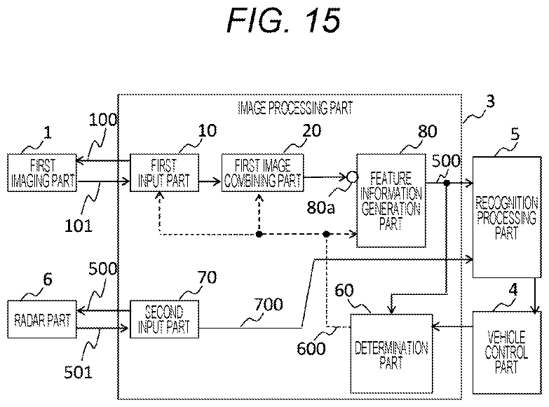

A fourth embodiment of the image processing device will be described with reference to FIG. 15. In the following description, the same components as in the first embodiment will be assigned the same reference numerals, and differences will be mainly described. The points that are not particularly described are the same as in the third embodiment. This embodiment is different from the third embodiment mainly in there is further provided a radar part that acquires surrounding information.

FIG. 15 is a configuration diagram of the image processing system S according to the fourth embodiment. The difference in the third embodiment from FIG. 14 is that the image processing system S further includes a radar part 6, and the image processing device 3 further includes a second input part 70. For example, the radar part 6 is a two-dimensional or three-dimensional laser distance meter. The second input part 70 outputs an output instruction 500 to the radar part 6 and acquires distance information 501 from the radar part 6. The second input part 70 outputs the acquired distance information 501 to the recognition processing part 5 as distance information 700. However, the second input part 70 may also output the distance information 700 to the feature information generation part 80.

### Fifth Embodiment

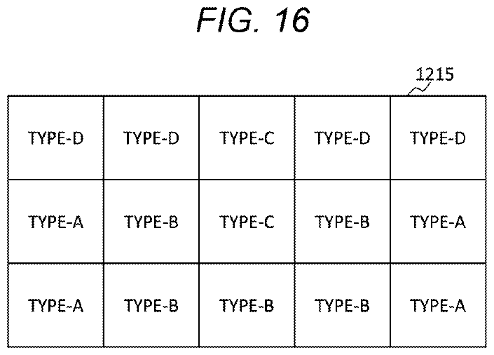

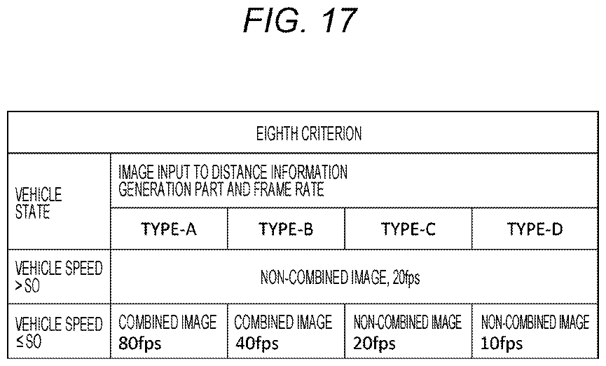

A fifth embodiment of the image processing device will be described with reference to FIGS. 16 and 17. In the following description, the same components as in the first embodiment will be assigned the same reference numerals, and differences will be mainly described. The points that are not particularly described are the same as in the first embodiment. This embodiment is different from the first embodiment mainly in that the processing is different depending on the area of the captured image.

In this embodiment, the first image combining part 20 and the second image combining part 40 divide the captured image into a plurality of processing areas, and the types of output images 102 and 202 and the frame rate for each processing area are changed according to the mode command signal 600. In this embodiment, the first imaging part 1 and the second imaging part 2 perform imaging at 80 fps. In addition, in this embodiment, the distance information generation part 50 generates distance information for each area of the input captured image. Further, the first image combining part 20 and the second image combining part 40 output images for each area of the captured image at a frequency specified by the determination part 60. For example, in a case where an output at 80 fps is specified for a certain area, an image input for that area is output every time. However, in the case of an output at 40 fps, an image is output every other time.

FIG. 16 is a diagram illustrating an example of dividing a captured image 1215 into processing areas. In the example illustrated in FIG. 16, the captured image is divided into five areas in the horizontal direction and three areas in the vertical direction, that is, a total of 15 areas, and each area is classified into one of four types of Type-A to D. The upper part of the captured image 1215, that is, the uppermost part is an area where a sky or a distant landscape is photographed, and four areas excluding the central area are classified as Type-D. The center in the horizontal direction is classified as Type-C except for the lowest level. The middle and lower part of the left and right ends are classified as Type-A. Then, the remaining area is Type-B. The Type-B area is an area where the bonnet of the mounted vehicle and the road on which the vehicle is traveling are photographed. The Type-A area corresponds to the left, right, and front sides of the mounted vehicle and requires rapid detection of obstacles such as pedestrians jumping out and moving bodies approaching.

FIG. 17 is a diagram for explaining the operation of the determination part 60 in a case where the eighth criterion that is a criterion peculiar to the fifth embodiment is adopted. In a case where the eighth criterion is adopted, the determination part 60 determines whether or not the vehicle speed of the mounted vehicle is faster than a predetermined speed S0. In a case where it is determined that the vehicle speed is faster than the predetermined speed S0, the determination part 60 gives an instruction to output a non-combined image at 20 fps to all areas. In a case where it is determined that the vehicle speed is equal to or less than the predetermined speed S0, the determination part 60 gives an instruction to output a combined image at 80 fps to the Type-A area, output a combined image at 40 fps to the Type-B area, output a non-combined image at 20 fps to the Type-C area, and output a non-combined image at 10 fps to the Type-D area.

According to the fifth embodiment described above, the following operational effects are obtained.

(10) The determination part 60 divides each of the plurality of images into a plurality of determination areas and determines the image to be input to the distance information generation part 50 as one of the combined image, the image A, and the image B for each determination area on the basis of at least one of the state of the vehicle and the state around the vehicle.

(11) The determination part 60 determines a frame rate of the image to be input to the distance information generation part 50 for each determination area on the basis of at least one of the state of the mounted vehicle and the state around the mounted vehicle. Therefore, it is possible to increase the frame rate of an area requiring special attention depending on the situation. Furthermore, it is possible to reduce the frame rate of an area with less necessity of calculating distance information such as an area where the sky is photographed and to reduce the load on the distance information generation part 50.

### Sixth Embodiment

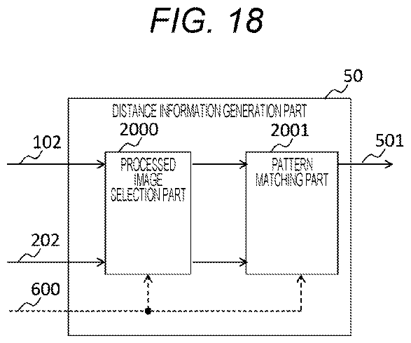

A sixth embodiment of the image processing device will be described with reference to FIGS. 18 to 20. In the following description, the same components as in the first embodiment will be assigned the same reference numerals, and differences will be mainly described. The points that are not particularly described are the same as in the first embodiment. This embodiment is different from the first embodiment mainly in that the distance information generation part 50 calculates motion vector information.

FIG. 18 is a configuration diagram of the distance information generation part 50. The distance information generation part 50 includes a processed image selection part 2000 and a pattern matching part 2001. The processed image selection part 2000 switches whether to output the input images 102 and 202 input at the same time according to the mode command signal 600 or to output two types of input images 102 (time T and time Tt) having different times. The pattern matching part 2001 switches whether to generate distance information based on the input images 102 and 202 input at the same time according to the mode command signal 600 or to generate motion vector information based on two types of input images 102 (time T and time Tt) having different times. The distance information or the motion vector information generated by the pattern matching part 2001 is output as feature information 501. Incidentally, the input image 202 may be used instead of the input image 102.

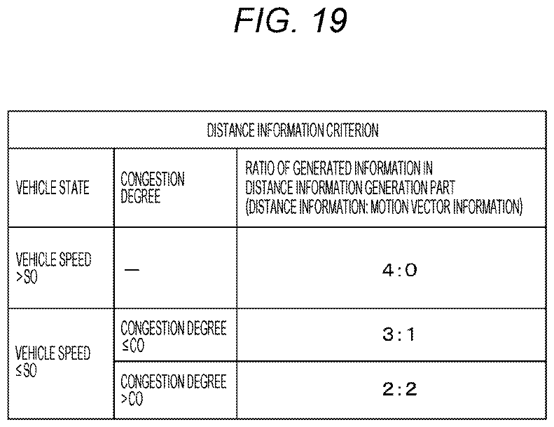

FIG. 19 is a diagram for explaining the operation of the determination part 60 in a case where a distance information criterion indicating an operation command to the distance information generation part 50 is adopted. Incidentally, in a case where the distance information criterion is adopted for the operation command to the distance information generation part 50, the sixth criterion using the same determination criterion may be adopted for the operation command to the first image combining part 20 and the second image combining part 40 or another criterion may be adopted. In a case where the distance information criterion is adopted, the determination part 60 evaluates the vehicle speed of the mounted vehicle and the congestion degree. In a case where the vehicle speed is faster than the predetermined speed S0, the mode command signal 600 for instructing to generate only distance information regardless of the congestion degree is output. In a case where the vehicle speed is equal to or less than the predetermined speed S0, and the congestion degree is equal to or less than C0, in order to detect the movement of the subject near the vehicle, one of the four frames generates motion vector information, and the remaining three frames outputs the mode command signal 600 for instructing to generate distance information. In addition, in a case where the vehicle speed is equal to or less than the predetermined speed S0 and the congestion degree is larger than C0, two of the four frames generate motion vector information, and the remaining two frames generate distance information, thereby improving the motion detection performance with respect to the subject near the vehicle.

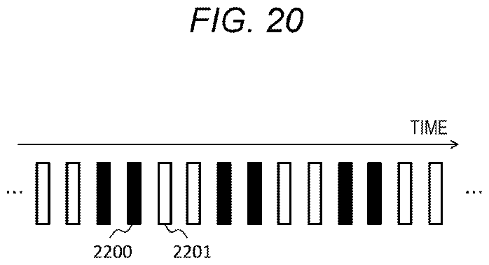

FIG. 20 is a diagram illustrating a processing example of the distance information generation part 50 in the last case illustrated in FIG. 19, that is, a case where the vehicle speed is equal to or less than S0, and the congestion degree is larger than C0. In FIG. 20, time passes from the left to the right in the drawing. In FIG. 20, a white square indicated by reference numeral 2201 indicates a motion vector information generation processing, and a black square indicated by reference numeral 2200 indicates a distance information generation processing. The distance information generation part 50 switches the processing every two frames as illustrated in FIG. 19.

According to the sixth embodiment described above, the following operational effects can be obtained.

(12) The distance information generation part 50 determines a ratio for generating the distance information and the motion vector information on the basis of the instruction from the determination part 60. The determination part 60 determines the ratio of the distance information and the motion vector information output by the distance information generation part 50 on the basis of at least one of the state of the mounted vehicle and the surrounding state of the mounted vehicle according to the distance information criterion. Therefore, the image processing device 3 can output the distance information and the motion vector information at an appropriate ratio according to the situation.

In each of the above-described embodiments and modifications, the program is stored in a ROM (not illustrated), but the program may be stored in a nonvolatile memory (not illustrated). In addition, the image processing device 3 may include an input/output interface (not illustrated), and if needed, a program may be read from another device via the input/output interface and a medium that can be used by the image processing device 3. Here, the medium refers to, for example, a storage medium removable from the input/output interface or a communication medium, that is, a wired, wireless, light or other network or a carrier wave or digital signal propagating through the network. In addition, some or all of the functions implemented by the program may be implemented by a hardware circuit or an FPGA.

The embodiments and modifications described above may be combined each other. Although various embodiments and modifications have been described above, the present invention is not limited to these contents. Other embodiments considered within the scope of the technical idea of the present invention are also included within the scope of the present invention.

The disclosure of the following priority application is hereby incorporated by reference.

Japanese Patent Application No. 2017-128821 (filed on Jun. 30, 2017)

### REFERENCE SIGNS LIST

1 first imaging part
2 second imaging part
3 image processing device
4 vehicle control part
5 recognition processing part
10 first input part
20 first image combining part
30 second input part
40 second image combining part
50 distance information generation part
60 determination part
70 second input part
80 feature information generation part
1200 congestion degree determination area
2000 processed image selection part
2001 pattern matching part

1. An image processing device mounted on a vehicle, comprising:
a captured image input part to which a plurality of captured images having different photographing sensitivities are input;
a combined image input part to which a combined image with high gradation generated using the plurality of captured images is input;
a feature information generation part that generates predetermined feature information using an input image; and
a determination part that determines an image to be input to the feature information generation part as one of the combined image and the captured images on a basis of at least one of a state of the vehicle and a state around the vehicle.

2. The image processing device according to claim 1, wherein the feature information generated by the feature information generation part is at least one of distance information and motion vector information.

3. The image processing device according to claim 1, wherein the determination part further determines a frame rate of the image to be input to the feature information generation part on the basis of at least one of the state of the vehicle and the state around the vehicle.

4. The image processing device according to claim 3, wherein the determination part maintains the frame rate of the image to be input to the feature information generation part within a predetermined range regardless of the state of the vehicle and the state around the vehicle.

5. The image processing device according to claim 1, wherein
the state of the vehicle includes at least one of a speed of the vehicle and position information of the vehicle, and
the state around the vehicle includes a congestion degree around the vehicle or a distance from the vehicle to a subject.

6. The image processing device according to claim 5, wherein
a combination of the captured images having parallax is input to the captured image input part for each of the plurality of photographing sensitivities,
a plurality of the combined images having parallax are input to the combined image input part, and
the distance from the vehicle to the subject is a distance calculated using the plurality of captured images or combined images having parallax.

7. The image processing device according to claim 5, wherein the congestion degree around the vehicle is calculated on a basis of the distance from the vehicle to the subject and a relative speed of the subject with respect to the vehicle.

8. The image processing device according to claim 1, wherein the determination part further divides each of the captured images and the combined image into a plurality of determination areas and determines the image to be input to the feature information generation part as one of the combined image and the captured images for each determination area on the basis of at least one of the state of the vehicle and the state around the vehicle.

9. The image processing device according to claim 8, wherein the determination part further determines a frame rate of the image to be input to the feature information generation part for each determination area on the basis of at least one of the state of the vehicle and the state around the vehicle.

10. The image processing device according to claim 2, wherein the determination part further determines a ratio of the distance information and the motion vector information generated by the feature information generation part on the basis of at least one of the state of the vehicle and the state around the vehicle.

11. The image processing device according to claim 1, further comprising an imaging part that photographs a periphery of the vehicle with different photographing sensitivities a plurality of times and inputs the plurality of captured images obtained by photographing to the captured image input part.

12. The image processing device according to claim 1, further comprising an image combining part that generates the combined image using the plurality of captured images input to the captured image input part and inputs the combined image to the combined image input part.
